(19) United States
(12) Patent Application Publication
(10) Pub. No.: US 2006/0129602 A1
(43) Pub. Date: Jun. 15, 2006

(54) Enable web sites to receive and process e-mail

(75) Inventors: Daniel B. Witriol, Issaquah, WA (US); John M. Leen, Kirkland, WA (US); Michael B. Silverstein, Kirkland, WA (US); Michael J. Morton, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/012,528

(22) Filed: Dec. 15, 2004

(51) Int. Cl. G06F 17/00

(52) U.S. Cl. 707/104.1

(57) ABSTRACT

A system and method is provided that enables a Web site to receive and process e-mails. Authorized users of and e-mail enabled modules of the Web site are capable of receiving e-mails sent to the Web site. E-mails sent to the Web site are archived in the Web site. E-mails directed to the Web site are automatically embedded with links leading to the Web site. Repetitive information such as reply history in e-mails is trimmed and placeholders are provided for missing e-mails in a discussion thread.

### FIELD OF THE INVENTION

The invention relates to computer software and, more particularly, to e-mail and Web content.

### BACKGROUND OF THE INVENTION

E-mail is presently one of the most commonly used tools for collaboration. Information is often communicated via e-mail long before the information appears anywhere else, such as on an Internet Web site. E-mail supports quick target ad hoc collaboration but suffers from poor organization, poor archiving, poor searching, and having no discernable structure.

Most e-mail clients support distribution lists. A distribution list is a single e-mail address that represents or includes a. group of e-mail addresses. An e-mail sent to a distribution list is sent to everyone whose e-mail address is included in the distribution list. Generally, a distribution list is a convenient way to distribute information to a group of recipients. For example, a distribution list can be used by users of a product to post questions and share information about the product. Ideally, previously asked questions and answers to the questions should be archived and be made easily available. Archiving answers can be used to prevent repeat answers from being sent to the members when a question is repeated on a distribution list. However, in reality, e-mail archives for distribution lists are difficult to set up. Even if a distribution list has an e-mail archive, the e-mail archive is often difficult for users to access. An unusable e-mail archive often results in duplication of effort, i.e., the same answers to questions and issues are redistributed over and over to those on the distribution list.

On the other hand, though not a good place for quick, real time, ad hoc collaboration, Web sites are good at sharing, structuring, and searching information. Unfortunately, as noted above, Web content tends to be stale compared to e-mail content since most early communication of answers to questions, for example, occurs through e-mails. Further, because most Web sites fail to centrally store important and update information, a Web site concerning a team may not include new appointments to the team, or documents or e-mails addressed to members of the team.

Thus, there exists a need to bring the current and relevant information in e-mails into the organized, searchable, and shared Web community, which can be either Internet or Intranet. There also exists a need to properly archive information concerning a distribution list so the archived information can be easily accessed.

### SUMMARY OF THE INVENTION

The invention addresses the above-identified needs by providing a system and method that enables a Web site to receive and process e-mails. The e-mail enabled Web site is associated with one or more e-mail addresses. E-mail sent to the Web site becomes part of the Web site content. E-mail addressed to the Web site e-mail address is automatically embedded with a link leading to the Web site. As a result, the Web site contains e-mail communication; and e-mail communication can easily access the Web site.

In accordance with one aspect of the invention, an e-mail enabled Web site may contain one or more e-mail enabled modules. A module of the Web site may be a discussion board, a calendar, a document library, an announcement list, etc. The e-mail enabled Web site creates a distribution list containing the e-mail addresses of authorized users of the Web site and of the e-mail enabled modules of the Web site. E-mail directed to the distribution list is received by the authorized users of the Web site and archived in an e-mail enabled module of the Web site.

In accordance with another aspect of the invention, an e-mail enabled Web site updates its distribution list with a current set of e-mail addresses associated with the Web site. The updating allows the distribution list to correctly reflect which users can access the content of the Web site and the current modules of the Web site that are capable of receiving e-mails. Preferably, a directory management service is used to process an update request from the Web site. Prior to updating, preferably, the directory management service first seeks permission to update the distribution list as requested. The permission may be obtained from an automated process. The permission may also be granted manually by a human being, such as a staffer in the human resources department or the IT department of an organization.

In accordance with a further aspect of the invention, when e-mail is addressed to an e-mail enabled module of the Web site, the Web site locates the module by searching a table that contains entries matching e-mail addresses with corresponding e-mail enabled modules.

In accordance with yet another aspect of the invention, an e-mail handler is associated with each e-mail enabled modules. The e-mail handler processes an e-mail directed to the e-mail enabled module before associating the e-mail with the module. For example, the e-mail handler may authenticate the e-mail to ensure it comes from a welcomed sender. The e-mail handler may also check the e-mail to ensure it has not been sent before. In addition, the e-mail handler may trim the content of the e-mail to remove repetitive information, such as the reply history of the e-mail. For example, the e-mail handler may abstract each reply history in the e-mail into a link, the actuation of which leads to the reply history itself. Preferably, an e-mail handler may be specifically designed to process email for a particular e-mail enabled module of a Web site.

In summary, the invention enables a Web site to receive and process e-mails. It integrates e-mail communication into the Web site and provides e-mail communication easy access to the Web site. As a result, the Web site stores current, relevant, and structured information. A user can access the Web site content using an e-mail addressed to the Web site.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1B are pictorial diagrams illustrating one exemplary implementation of the invention;

FIGS. 2A-2B are pictorial diagrams illustrating an exemplary implementation of a user interface for creating an e-mail enabled team site;

FIG. 3 is a pictorial diagram illustrating an exemplary user interface for creating an e-mail enabled module of a team site;

FIG. 4 is a flow diagram illustrating an exemplary implementation of a process for creating an e-mail enabled team site;

FIG. 5 is a flow diagram illustrating an exemplary implementation of a routine for enabling a team site to receive and process e-mails, suitable for use in FIG. 4;

FIG. 6 is a flow diagram illustrating an exemplary implementation of a routine for archiving e-mail sent to a distribution list of a team site, suitable for use in FIG. 4;

FIG. 7 is a block diagram illustrating an exemplary implementation of a synchronization mechanism that processes a request from an e-mail enabled team site to a distribution list associated with the team site;

FIG. 8 is a system diagram illustrating an exemplary implementation of a computing system for sending an e-mail to an e-mail enabled module of a team site;

FIG. 9 is a block diagram illustrating an exemplary implementation of a table that maps an e-mail address to an e-mail enabled module;

FIG. 10 is a flow diagram illustrating an exemplary implementation of a process for sending an e-mail to an e-mail enabled module;

FIG. 11 is a block diagram illustrating an exemplary implementation of an e-mail handler class;

FIG. 12 is a pictorial diagram illustrating one exemplary e-mail of an e-mail enabled module, wherein the reply history of the e-mail has been trimmed;

FIG. 13 is a pictorial diagram illustrating one exemplary user interface for centrally configuring e-mail settings of a Web server hosting an e-mail enabled team site; and

FIG. 14 is a pictorial diagram illustrating one exemplary user interface for configuring e-mail settings for an e-mail enabled module such as a discussion board.

### DETAILED DESCRIPTION OF THE PREFERRED EMBODIMENT

In general, this invention enables a Web site to receive and process e-mails, and to archive the e-mails in the Web site. The invention also embeds a link to the Web site in outgoing e-mail directed to the Web site, thus enabling the Web site content to be accessible from that e-mail. As a result, the Web site contains current, relevant, and structured content, which can be accessed by a user, including from an e-mail.

Embodiments of the invention e-mail enable one or more modules hosted by the Web site. A module can be a discussion board, a calendar, a document library, an announcement list, etc. An e-mail handler associated with the e-mail enabled module processes e-mail addressed to the module. The e-mail handler then associates the e-mail with the module, e.g., stores the e-mail in the module. The invention also creates a distribution list for the Web site. The distribution list includes e-mail addresses of authorized users of the Web site and of the e-mail enabled modules of the Web site. E-mail sent to the distribution list is archived in one of the e-mail enabled modules of the Web site. When composing an e-mail directed to one of the e-mail addresses associated with the Web site, a user may access the Web site through a link that is automatically embedded in the e-mail.

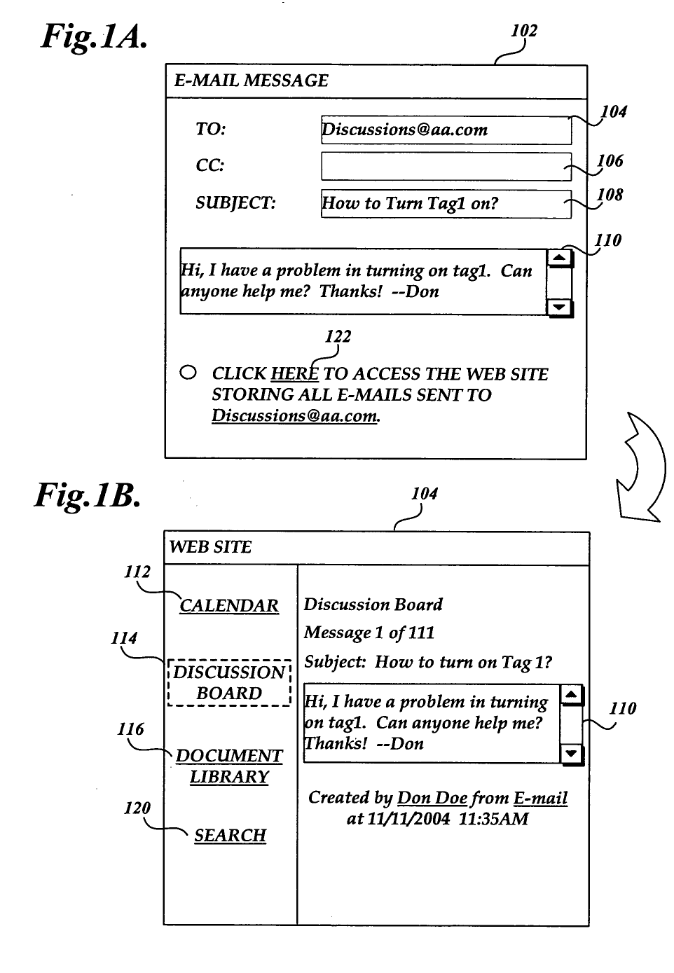

FIG. 1A is a pictorial diagram illustrating e-mail 102 that is addressed to an e-mail enabled Web site 104(FIG. 1B). The e-mail 102 contains a “To” field 104, a “CC” field 106, a “Subject” field 108, and a message body 110. As shown in FIG. 1, the e-mail 102 is addressed to discussions@aa.com; it has “How to turn on tag1?” as the subject; and its message body contains “Hi, I have a problem in turning on tag1. Can anyone help me? Thanks!—Don.”

FIG. 1B illustrates an example of an e-mail enabled Web site 104. The Web site 104 contains a calendar 112, which displays all meeting invitations and appointments sent to users allowed to access the Web site 104, i.e., the team of the Web site 104. The Web site 104 also contains a discussion board 114 where members of the team can discuss issues concerning the team or the project that the team works on. The Web site 104 may also contain one or more document libraries 104 that store files and e-mail attachments, such as pictures or forms.

As shown in FIG. 1A, the e-mail 102 is addressed to discussions@aa.com, which is the e-mail address for the discussion board 114 illustrated in FIG. 1B. After successfully receiving and processing the e-mail 102, the discussion board 114 displays the content of the e-mail 102.

In embodiments of the invention, e-mail directed to an e-mail enabled Web site may be archived in a module of the Web site. The module may be created specifically for archiving purpose; it can also be any of the existing modules in the Web site. By archiving e-mail communication, the Web site enables a user to access e-mail communication from a central location, i.e., the Web site.

When the e-mail 102 is being composed, a link 122 to the e-mail enabled Web site 104 is automatically embedded. The link 122 is provided based on the designated e-mail addresses in the “To” field 104 and/or the “CC” field 106 of the email 102. Optionally, the Web site 104 may have a search 120 functionality that allows a user to search for specific information in the Web site 104.

One exemplary application of the invention is to e-mail enable a team Web site, i.e., a team site. A team site is used by a group of people, i.e., the team, working collaboratively toward a common goal or end point. The team shares documents and information, has meetings, and performs other types of communication with each other. Microsoft® Windows® SharePoint® service provides an illustration of such a team site setting. While the following text describes exemplary embodiments of the invention in the general context of a team site, those skilled in the art will appreciate the invention may be practiced on any Web site that may benefit from the ability to receive and process e-mail.

The following text first describes how to enable a team site to receive and process e-mail. Then a process is described for sending e-mail to an e-mail enabled module of the team site. Finally, details are presented on how to centrally configure settings of an e-mail enabled team site.

### Section 1 Enabling E-mail on a Team Site

One aspect of the invention enables a Web site to receive and process e-mails. For example, when a user creates a team site, the user may specify an e-mail address that can be used to communicate with members of the team site (“site members”). An e-mail sent to the e-mail address will go to all the site members and will be archived in the team site.

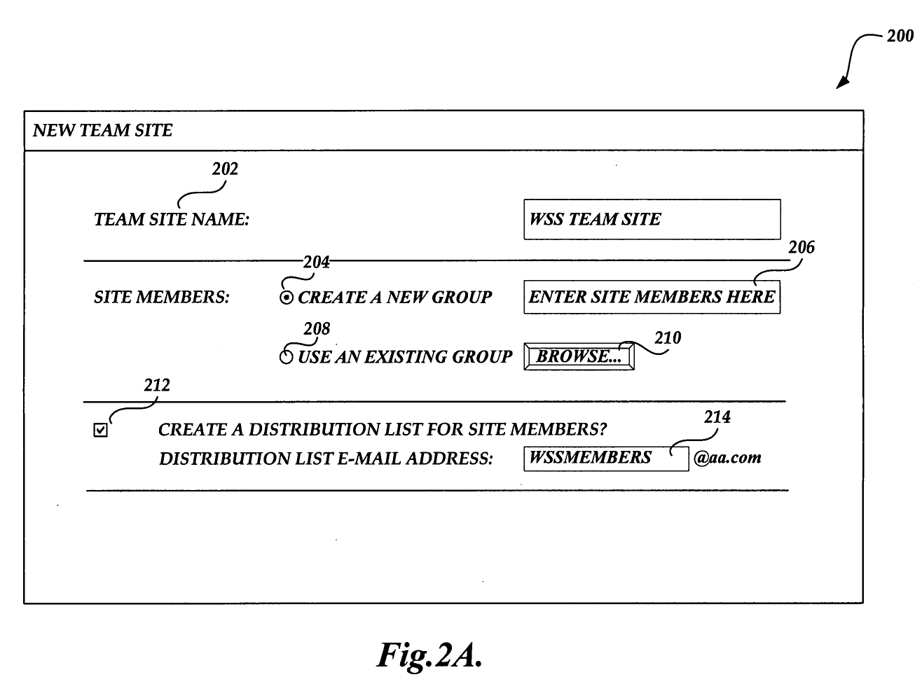

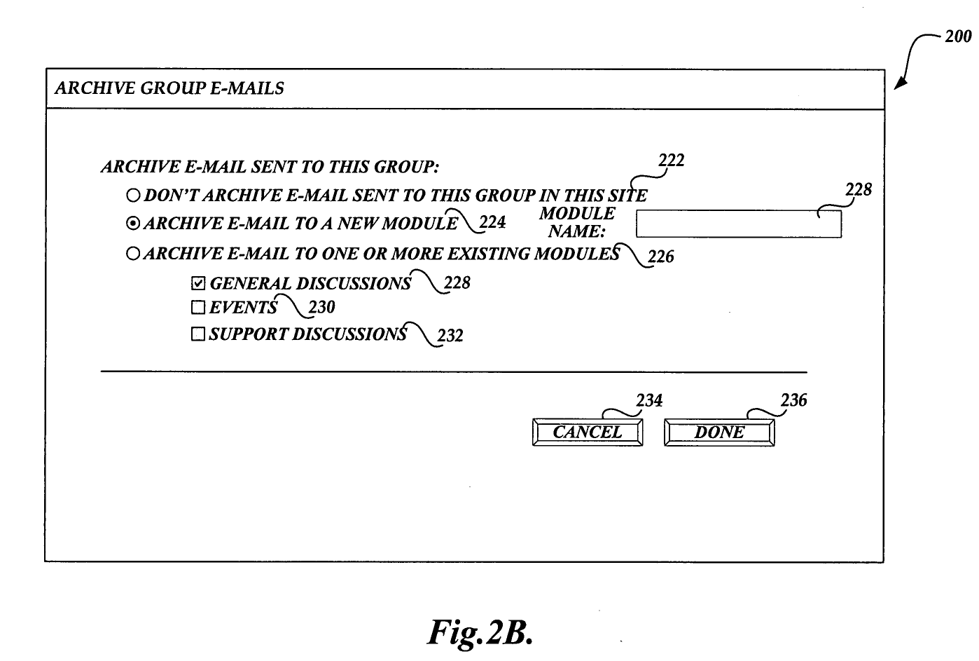

FIGS. 2A-2B illustrate one exemplary user interface 200 for creating a team site that has the ability to receive and process e-mails. Through the user interface 200, a user may specify the name 202 of the team site, for example, to be “WSS Team Site.”

A user may further establish a group comprised of the site members. Site members have the privilege to receive e-mails sent to the team site and access resources in the team site. In embodiments of the invention, a user may create a new group for the team site or use an existing group. As shown in FIG. 2, a user may elect to create a new group by selecting the “Create A New Group” checkbox 204 and specifying the site members in the text box 206. A user can also select the “Use An Existing Group” checkbox 208 and actuate the “Browse . . . ” button 210 to locate an existing group to be the group for the team site.

The user may then create a distribution list comprising e-mail addresses of the site members, for example, by selecting the checkbox 212. The user then needs to specify the e-mail address for the distribution list in the text box 214. For example, in FIG. 2, the user specifies the e-mail address for the distribution list to be “WSSMembers@aa.com.”

In embodiments of the invention, a team site may contain multiple modules. For example, a team site may host modules such as discussion boards, calendars, document libraries, announcement lists, etc. The team site can handle multiple types of e-mails and route them appropriately. For example, the team site can route e-mail discussions into a discussion board in the team site. Attachments in e-mail can be saved into a document library in the team site. Meeting invitations sent to the team may be saved in the calendar. And announcements sent to the team site may be collected in an announcement list. As a result, information in a team site may be organized in a coherent, structured, and relevant manner, easy for site members to browse and use.

Embodiments of the invention allow a user to specify whether to archive e-mail sent to the group of a team site, for example, through a user interface such as the user interface 200. As shown in FIG. 2B, a user may do so by selecting either of the check boxes for “don't archive e-mail sent to this group in this site” 222, “archive e-mail to a new module” 224, and “archive e-mail to one or more existing modules” 226. If the user selects the “archive e-mail to a new module” 224 option, the user should further specify the name 228 of the new module. If the user selects the “archive e-mail to one or more existing modules” 226 option, the user may select from existing modules. For example, as shown in FIG. 2B, the illustrated team site has existing modules titled “General Discussions” 228, “Events” 230, and “Support Discussions” 232.

The user interface 200 may further include a Cancel button 234, the actuation of which cancels all user input in the user interface 200. The user interface 200 may also include a Done button 236, the actuation of which initiates an underlying process that creates a team site according to the information entered by the user in the user interface 200.

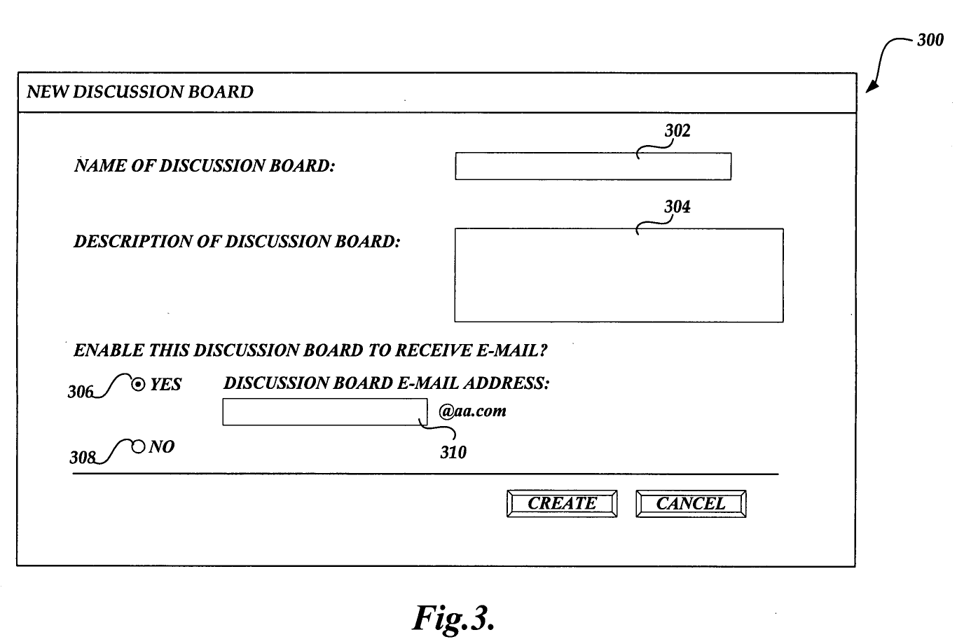

Besides enabling a team site to receive and process e-mails, embodiments of the invention also allow modules hosted by a team site to receive and process e-mails. FIG. 3 illustrates one user interface 300 that allows a user to e-mail enable a discussion board of the team site illustrated in FIGS. 2A-2B. As shown in FIG. 3, a user may specify a name 302 for the discussion board. A user may also provide a description 304 of the discussion board. More importantly, a user may specify whether to enable the discussion board to receive e-mails by checking a YES button 306 or a NO button 308. If a user selects the YES button 306 to enable the discussion board to receive e-mails, the user then specifies an e-mail address 310 for the discussion board.

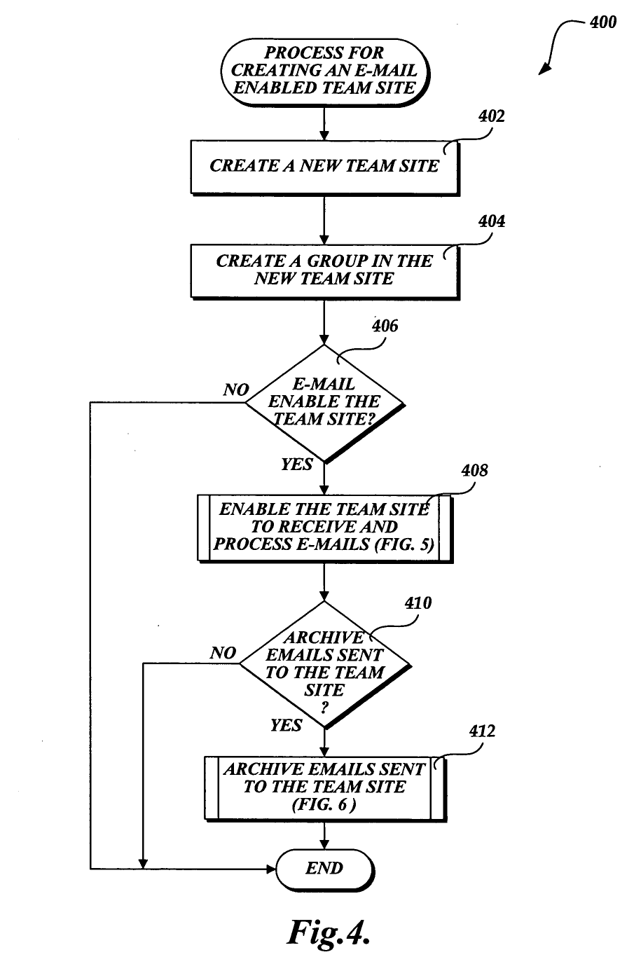

FIG. 4 illustrates one exemplary implementation of a process 400 for creating an e-mail enabled team site. The process 400 is described with reference to the user interface 200 illustrated in FIGS. 2A and 2B and the user interface 300 illustrated in FIG. 3.

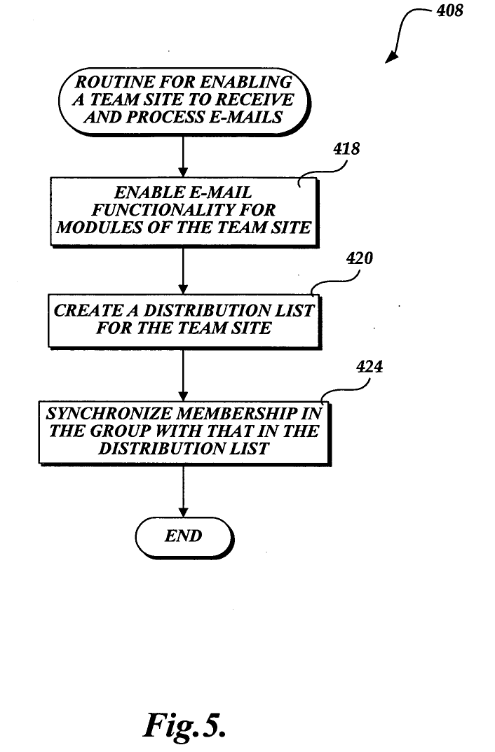

In the exemplary implementation illustrated in FIG. 4, the process 400 first creates a new team site, for example, with the information specified by a user in the user interface 200. See block 402. The process 400 then establishes a group for the new team site, for example, by utilizing the site membership information specified by the user in the user interface 200. See block 404. Next, the process 400 checks whether the team site should be e-mail enabled, i.e., whether the team site should be able to receive and process e-mails. See decision block 406. If the answer is YES, the process 400 executes a routine 408 that enables the team site to receive and process e-mails. See block 408. FIG. 5 illustrates one exemplary implementation of the routine 408 and will be discussed in detail shortly.

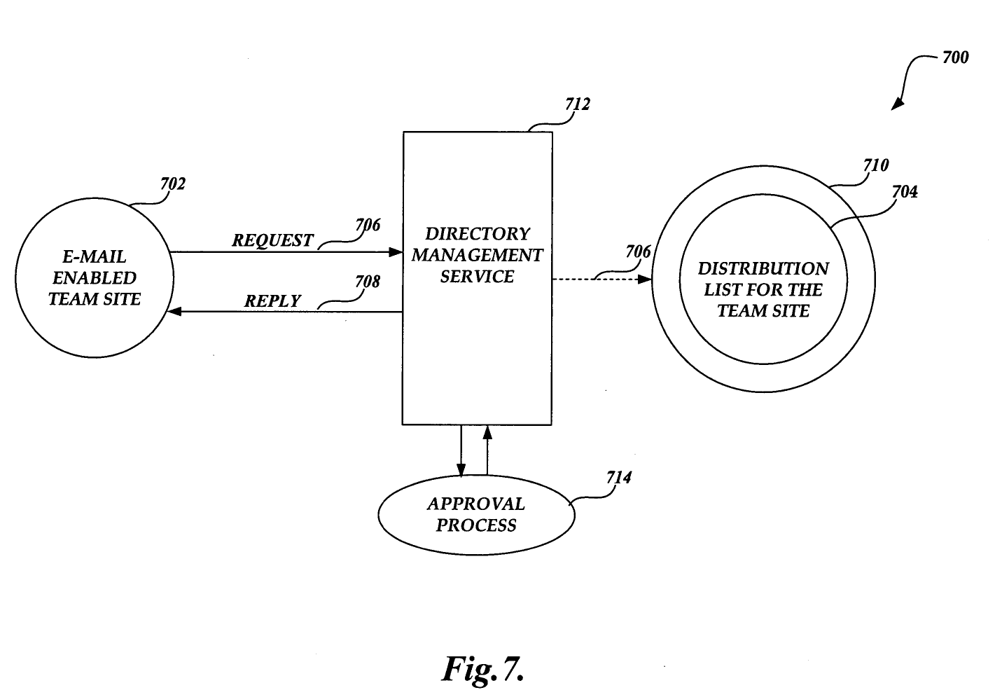

As noted above when describing the user interface 200, e-mail received by a team site may be archived in the team site. Consequently, after executing the routine 408, the process 400 proceeds to check whether e-mail sent to the team site should be archived. See decision block 410. If the answer is YES, the process 400 proceeds to a routine 412 that archives e-mail sent to the team site. See block 412. FIG. 7 illustrates one exemplary implementation of the routine 412 and will be discussed in detail later. The process 400 then exits.

If the answer to the decision block 406 or the decision block 410 is NO, meaning that no e-mail functionality or no e-mail archive functionality is desired for the team site, the process 400 exits.

As noted above when describing process 400, FIG. 5 illustrates one exemplary implementation of the routine 408 that enables a team site to receive and process e-mails. In essence, the routine 408 enables one or more modules in the team site to receive and process e-mails. The routine 408 then creates a distribution list for the team site. Finally, the routine 408 synchronizes membership in the group of the team site with that in the distribution list of the team site.

First, the routine 408 may enable one or more modules in the team site to receive and process e-mails. See block 418. As noted above, a team site may include one or more modules such as discussion boards, team calendars, document libraries, etc. For instance, if a team site includes modules such as a discussion board and a team calendar, the routine 408 may enable the discussion board and the team calendar to receive e-mails by creating e-mail addresses for the discussion board and the team calendar. For example, the routine 408 may enable the discussion board of the team site “WSS Team Site” illustrated in FIG. 2 to receive e-mails by providing the discussion board with an e-mail address such as “WSSMembers.Discussions@aa.com.” The routine 408 may enable e-mail functionality on the team calendar of the “WSS Team Site” by assigning the team calendar an e-mail address such as “WSSMembers.Calendar@aa.com.” In embodiments of the invention, a user may specify the e-mail addresses for the modules of a team site through a user interface such as the user interface 300 illustrated in FIG. 3.

The routine 408 then creates a distribution list for the team site, for example, by using the e-mail address information specified by a user in the textbox 214 (FIG. 2). See block 420. In embodiments of the invention, the distribution list comprises the site members of the team site. Thus, the site members of the team site can receive e-mails sent to the team site through the distribution list. The distribution list may also contain the e-mail addresses for the e-mail enabled modules of the team site. For example, for the “WSS Team Site” illustrated in FIGS. 2A-3, its distribution list may include the discussion board's email address “WSSMembers.Discussion@aa.com” and the calendar's e-mail address “WSSMembers.Calendar@aa.com.”

In addition, the routine 408 synchronizes membership in the group of the team site with that in the distribution list of the team site. See block 424. In order for an e-mail sent to the distribution list of a team site to be received by the site members in a group of the team site, the membership in the distribution list should include current members in the group. In embodiments of the invention, a synchronization mechanism is engaged to update the distribution list with any change in the memberships in the group. FIG. 7 provides a block diagram illustrating one exemplary implementation of the synchronization mechanism and will be discussed in detail later.

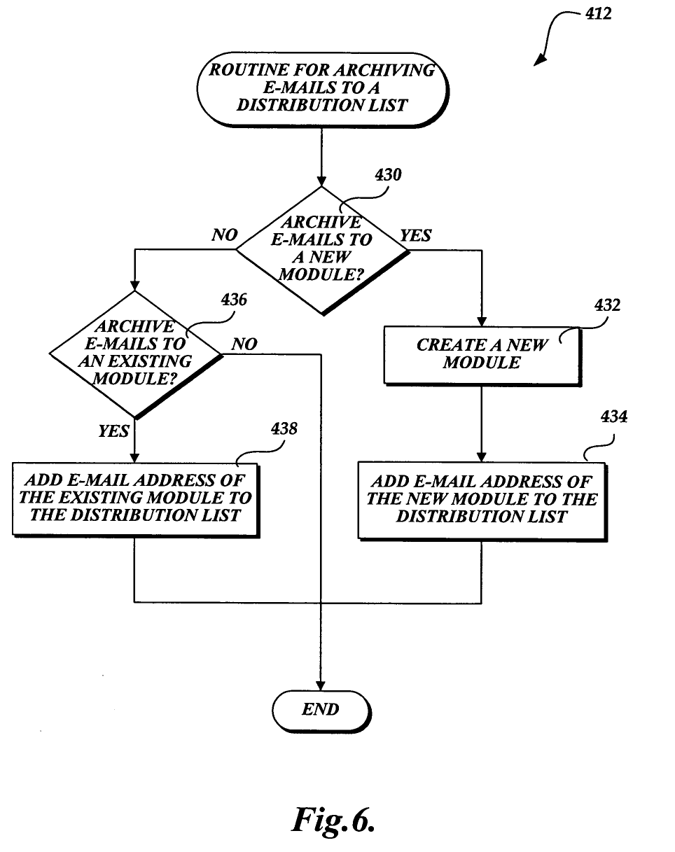

FIG. 6 illustrates one exemplary implementation of the routine 412 (FIG. 4) that archives e-mail sent to a team site. In essence, the routine 412 archives e-mail sent to the group of a team site so that its site members can easily access the information in the e-mail from the team site. As illustrated in FIG. 6, the routine 412 first checks whether the archive should go to a new module in the team site. See decision block 430. If the answer is YES, the routine 412 creates a new module, e.g., a new discussion board for the team site to host the archive, for example, through the user interface 300 illustrated in FIG. 3. See block 432. The routine 412 then adds the e-mail address of the new module to the distribution list of the team site. See block 434. The routine 412 then exits. In case the answer to decision block 430 is NO, the routine 412 proceeds to check if the archive should go to an existing module in the team site. See decision block 436. If the answer is YES, the routine 412 adds the e-mail address of the existing module to the distribution list of the team site. See block 438. The routine 414 then exits.

In embodiments of the invention, e-mail addresses associated with a Web site may be managed from the Web site. For example, an e-mail enable Web site may issue a request to create a contact for the Web site in an e-mail directory or to update the distribution list of the Web site with any changes with the memberships in the group of the Web site. Such a request is executed through the synchronization mechanism mentioned when describing the routine 408 (FIG. 5). FIG. 7 provides a block diagram illustrating one exemplary implementation of the synchronization mechanism. As shown in FIG. 7, an e-mail enabled team site 702 may issue a request 706. The request 706 can be to update the distribution list 704 of the team site 702 according to any membership change in the group of the team site 702. For example, the request 706 may ask to add or delete a group member from the distribution list 704.

The request 706 can also be to create an archive for the team site 702. As described above with reference to FIG. 6, the archive may be associated with an existing module of the team site 702. The archive may also go to a newly established module for the team site 702. If a new module is established for the team site 702 to store the archive, an e-mail address is created for the new module and added to the distribution list 704.

Furthermore, the request 706 can be to add a contact into an e-mail directory 710, which may host the distribution list 704. A contact is a friendly name of an actual e-mail address. Often, an e-mail address can be long and loaded with technical details. One such e-mail address is announce server1.seattle.kingcounty.washington.corp.aa.com. To increase user friendliness, a friendly name such as announce@aa.com can be used to represent the actual e-mail address. In embodiments of the invention, the request 706 may ask for a friendly name representing an actual e-mail address to be added to the e-mail directory 710. The request 706 may also contain other instructions.

In some embodiments of the invention, a directory management service 712 is engaged to process a request 706. Preferably, the directory management service 712 first seeks permission to execute the request 706 by calling, for example, an approval process 714. If the approval process 714 permits the request 706, the directory management service 712 executes the request and adds necessary information into the distribution list 704. If the approval process 714 denies the request, the directory management service 712 will not process the request 706 further. This dependency of the execution of the request 706 on the output of the approval process 714 is illustrated in FIG. 7 by a dash-lined request 706 between the directory management service 712 and the distribution list 704. The directory management service 712 may send a reply 708 back to the team site 702, indicating whether the request 706 has been successfully executed.

The approval process 714 can be automated and be a part of the directory management service 712. The approval process 714 can also be performed manually. For example, a human resources department or an IT department in an organization may verify whether a new group member of the team site 702 should be added to the distribution list 704. In some situations, the approval process 714 can take a while. In such situations, the directory management service 712 may postpone execution of the request 706 until hearing back from the approval process 714, or may execute the request 706 without hearing back from the approval process 714. In the latter approach, the team site 702 may send a follow-up request to the directory management service 712 to seek an answer from the approval process 714. If the directory management service 712 has received an answer from the approval process 714, the directory management service 712 sends a confirmation reply to the team site 702. If the confirmation reply contains a denial of the request 706, the team site 702 sends another request that voids the effects of the request 706 in the case that the request 706 has been executed and information has been added to the distribution list 704.

In summary, embodiments of the invention e-mail enable a Web site such as a team site by creating e-mail addresses for one or more modules contained by the Web site. A distribution list is created that contains the e-mail addresses of the site members of the Web site and of the e-mail enabled modules of the Web site. The Web site may manage the e-mail addresses associated with the Web site by sending requests to a directory management service, which may execute the requests in an e-mail directory accordingly. The invention also enables the Web site to archive e-mails sent to the Web site.

### Section 2 Sending E-mail to an E-mail Enabled Module

Embodiments of the invention route an e-mail for an e-mail enabled module of a Web site to an SMTP server for the Web server hosting the Web site. Incoming e-mail to the SMTP server are periodically polled by a timed e-mail service. When a new e-mail is detected, the destination e-mail address in the e-mail is used to determine which module in a Web site the e-mail is for. In embodiments of the invention, each mail enabled module is associated with an e-mail handler. The e-mail handler processes an e-mail directed to the e-mail enabled module and archives the e-mail to the e-mail enabled module.

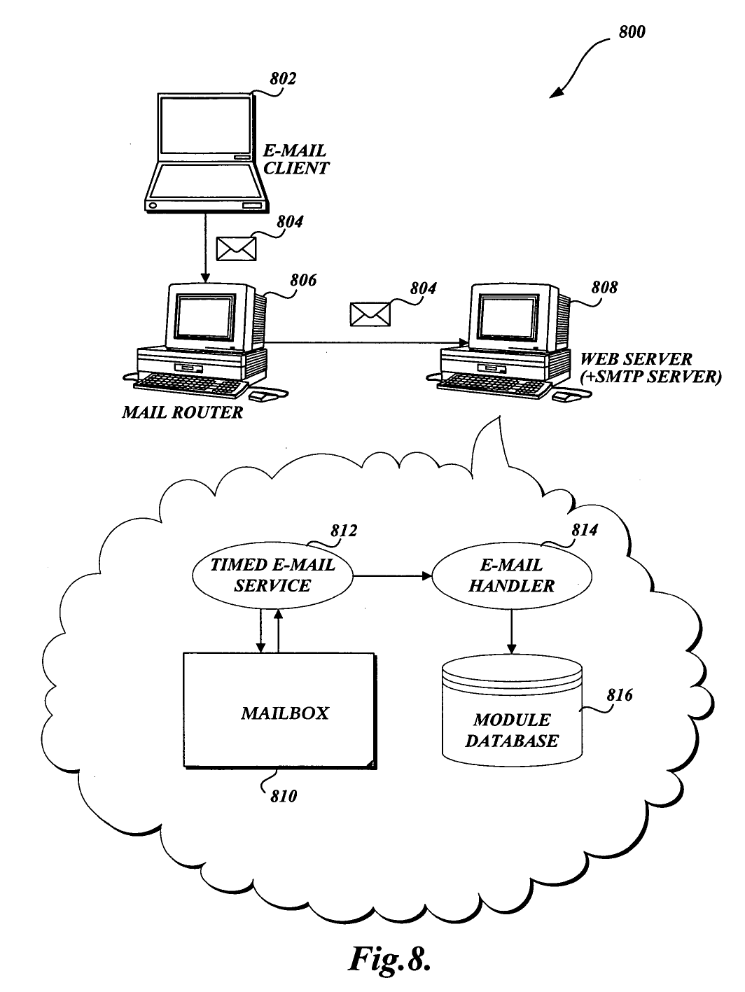

FIG. 8 is a block diagram illustrating one exemplary computing system 800 for sending an e-mail to an e-mail enabled module in a team site. As shown in FIG. 8, the computing system 800 includes at least one e-mail client 802, a mail router 806, and a Web server 808. The Web server may host an SMTP server that processes e-mails directed to Web sites hosted by the Web server 808. Alternatively, the SMTP server may exist on another computer and communicate with the Web server 808 through a network. In embodiments of the invention, the computing system 800 can be a single computer wherein the e-mail client 802, the mail router 806, and the Web server 808 are located on the same machine. In other embodiments of the invention, the computing system 800 can be a distributed computing system wherein the e-mail client 802, the mail router 806, and the Web server 808 are located on different machines and communicate with each other through a network.

In some embodiments of the invention, multiple Web servers 808 or SMTP servers associated with a Web server 808 can exist in the computing system 800 (FIG. 8), thus improving system scalability and ensuring that the computing system 800 operates even when some of the Web servers 808 fail. For example, three SMTP servers, Mail1.aa.com, Mail2.aa.com, Mail3.aa.com, may exist in the computing system 800. E-mails sent to aa.com generally are distributed between Mail1.aa.com and Mail2.aa.com. E-mail will be sent to Mail3. aa.com only if the Mail1 and Mail2 servers fail.

A user composing an e-mail 804 in an e-mail client 802 may address the e-mail 804 to the e-mail address of an e-mail enabled module in a team site. For example, the e-mail address can be discussions@aa.com. In embodiments of the invention, the e-mail 804 is first routed through the mail router 806. The mail router 806 can be, for example, a Microsoft® Exchange Server. In some embodiments of the invention, the mail router 806 maps a friendly address to an actual e-mail address. For example, the exemplary friendly address discussions@aa.com may be mapped to OneNoteDiscussions@server1.Seattle.KingCounty.Washington.corp.aa.com. The mail router 806 then routes the e-mail 804 containing the actual e-mail address to the Web server 808.

In some embodiments of the invention, the Web server 808 is configured to only accept e-mail from a trusted mail router 806. In other words, the Web server 808 only accepts connections from a trusted mail router 806. The server 808 can also be configured to accept e-mails from every user. Another alternative is to configure the Web server 808 to accept messages from specific users. Yet another alternative is to configure the Web server 808 to accept e-mails from everyone except specific users.

Generally, the Web server 808 saves a received e-mail 804 to a mail drop folder called MailBox 810. The MailBox 810 may exist on the hard drive of the Web server 808. Alternatively, it may also be on a standalone SMTP server. In embodiments of the invention, a timed e-mail service 812 polls the MailBox 810 periodically. The poll frequency is configurable. For example, it can be every two minutes, two hours, or two days.

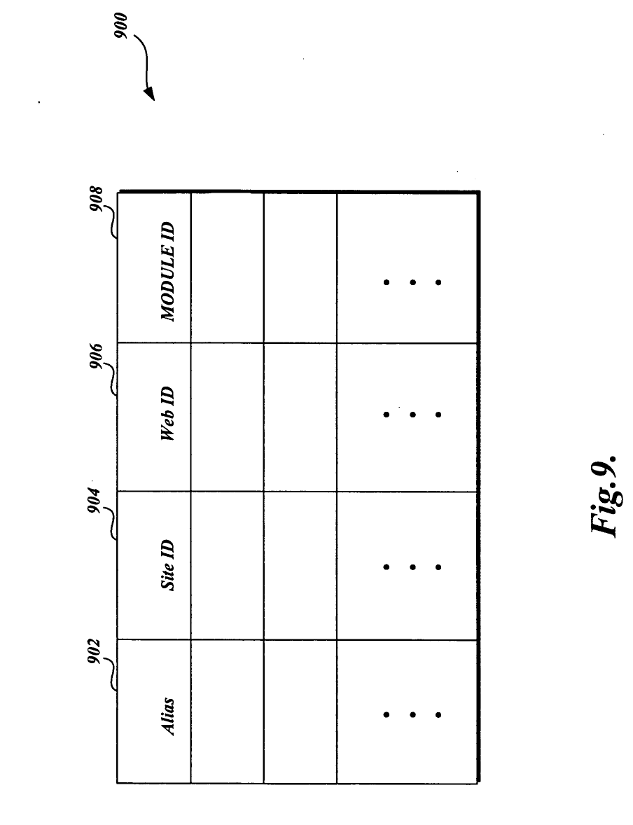

Upon retrieving a new e-mail 804, the timed e-mail service 812 routes the e-mail 804 to the appropriate e-mail enabled module according to the value of the destination e-mail address in the e-mail 804. In embodiments of the invention, a table that maps an e-mail address to an e-mail enabled module controls the e-mail routing by the timed e-mail service 812. FIG. 9 illustrates one exemplary implementation of such a table 900. As shown in FIG. 9, the table 900 contains four columns: Alias 902, Site ID 904, Web ID 906, and Module ID 908. Alias 902 contains the e-mail address for an e-mail enabled module. Site ID 904 identifies the collection of team sites that includes the team site hosting the e-mail enabled module. Web ID 906 identifies the team site itself. Module ID 908 identifies the e-mail enabled module. Each entry in the table 900 is unique, thus guaranteeing a 1-to-1 mapping between an Alias 902 and a (Site ID 904, Web ID 906, Module ID 908) triplet and, hence, an e-mail enabled module.

Returning to FIG. 8, in embodiments of the invention, an e-mail handler 814 is associated with each e-mail enabled module. Alternatively, an e-mail handler 814 may be provided for each type of e-mail enabled modules, such as a distribution list, a discussion board, a calendar, etc. After identifying the appropriate e-mail enabled module associated with the destination e-mail address of the e-mail 804, the timed e-mail service 812 locates the corresponding e-mail handler 814 associated with the e-mail enabled module. The e-mail handler 814 processes the e-mail 804 and associates it with the corresponding module, for example, by depositing the e-mail in a module database 816 that stores the module.

If the e-mail 804 is sent to a distribution list, including e-mail addresses of multiple e-mail enabled modules, multiple e-mail handlers associated with the multiple modules are identified. The multiple e-mail handlers then process the e-mail 804 and store it in the corresponding e-mail enabled modules.

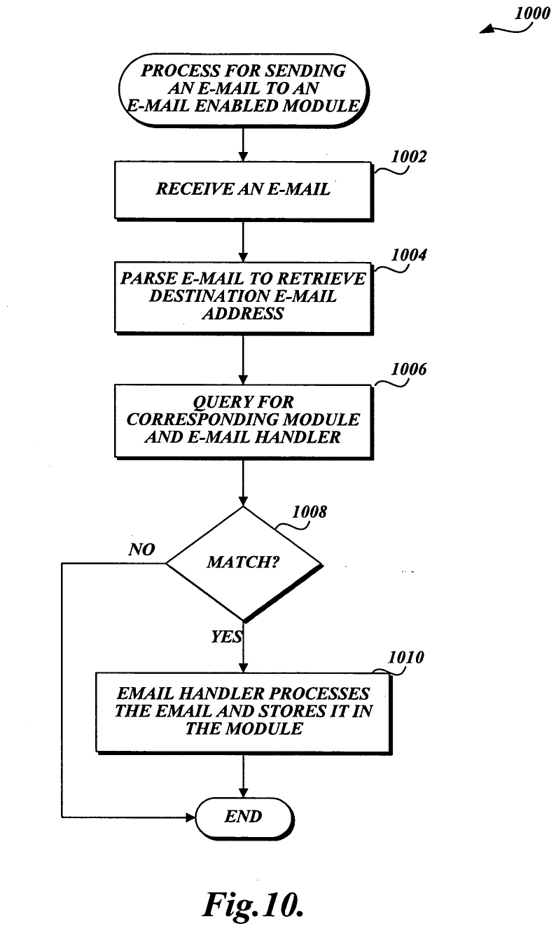

FIG. 10 illustrates one exemplary process 1000 for sending an e-mail to an e-mail enabled module. In essence, the process 1000 parses the header of the e-mail to retrieve the destination e-mail address, which is used to identify the corresponding e-mail enabled module. The process 1000 then searches for the e-mail handler associated with the module. The e-mail handler then processes the e-mail and stores it in the module.

As shown in FIG. 10, the process 1000 starts upon receiving an e-mail. See block 1002. In some embodiments of the invention, the process 1000 authenticates the e-mail to ensure that the e-mail comes from an authenticated mail router, such as the mail router 806 illustrated in FIG. 8. The process 1000 then parses the header of the e-mail to identify its destination e-mail address. See block 1004. Usually, the destination e-mail address in the e-mail is a friendly name that hides the actual e-mail address. The process 1000 locates the actual e-mail address using the friendly name. The process 1000 then queries a mapping table such as the table 900 illustrated in FIG. 9 to identify the module associated with the actual e-mail address and the e-mail handler associated with the module. See block 1006.

The process 1000 then checks to see if it has located an e-mail enabled module that is mapped to the e-mail address. See decision block 1008. If the answer is NO, the process 1000 exits. If the answer is YES, the e-mail handler associated with the module processes the e-mail and stores the e-mail in the module. See block 1010. The process 1000 then exits.

In embodiments of the invention, an e-mail handler such as the e-mail handler 814 illustrated in FIG. 8 processes an e-mail by performing authentication, field mapping, e-mail trimming, and/or other parsing and filtering functionalities on the e-mail. For example, a Web server such as the Web server 808 may be configured to accept e-mails from everyone, specific users, or everyone except specific users. The e-mail handler 814 ensures that the e-mail 804 is from an authentic sender, i.e., complies with the configuration settings of the Web server 808. The e-mail handler 814 may also scan the e-mail to ensure it is virus-free, or conduct other standard e-mail filtering functions if they are available.

In an exemplary embodiment of the invention, an e-mail handler maps the “To,” “From,” “CC,” and “Subject” fields in an e-mail to the “E-mail To,” “E-mail From,” “E-mail CC,” and “E-mail Subject” fields in the corresponding module, at a minimum. Different e-mail handlers may implement the field mapping differently. For example, an e-mail handler for a discussion board may map the “From” field in an e-mail to a “Posted By” field in the discussion board. On the other hand, an e-mail handler for a document library may map the “From” field in an e-mail to a “Created By/Modified By” field in the document library.

In embodiments of the invention, an e-mail handler may also be able to detect duplicated e-mails, thus preventing multiple identical e-mails from showing up in an e-mail enabled module. In an exemplary embodiment of the invention, duplication detection is achieved by generating a hash of an e-mail and storing the hash of the e-mail in an “e-mail hash” field in the e-mail's corresponding module. The hash of a new e-mail can compare to the hashes of existing e-mails in the module to identify duplicates.

In an exemplary embodiment of the invention, a class named TimerJobIncomingEmail periodically handles one or more e-mails obtained by the timed e-mail service 812. The class TimerJobIncomingEmail has a method HandleEmailDirectory that takes the name of the MailBox 810 (FIG. 8) and calls another method HandleEmailFile for each e-mail in the MailBox 810. The HandleEmailFile method takes as a parameter another method EmailMap that translates the e-mail address in the e-mail into its corresponding e-mail enabled module. The method HandleEmailFile then uses the module to locate an e-mail handler that performs the actual mail delivery.

In some embodiments of the invention, the above-described methods may contain multiple try/catch/finally blocks to ensure that an exception occurred during the delivery of one e-mail does not prevent the delivery of subsequent e-mails. In addition, whenever necessary, the method HandleEmailFile deletes the e-mail file when the method has finished processing the e-mail. Thus, e-mails are not kept in the MailBox 810 on the hard drive of the Web server 808 any longer than is necessary.

In some embodiments of the invention, a class named EmailMap manages the mapping table such as the table 900 illustrated in FIG. 9. In embodiments of the invention, the EmailMap class contains a method PutAlias. When given an e-mail address and its corresponding module, the PutAlias method adds an entry to the table 900. The method throws an exception if the entry could not be created, e.g., there is already an entry in the table containing the e-mail address.

The class EmailMap also contains a method GetModuleFromDatabase. Given an e-mail address, the method GetModuleFromDatabase returns the e-mail enabled module to which the e-mail address corresponds. The method returns NULL if no such e-mail module exists in the database. In addition, whenever the method GetModuleFromDatabase is called to look up a module whose entry in the e-mail enabled modules table points to a nonexistent module, that entry is removed. The method GetModuleFromDatabase may be called by the GetHandler method in the EmailMap class. To avoid unnecessary queries for e-mail handlers, the GetHandler method first checks a cache to see if the cache stores the desired mapping already; if not, the GetHandler calls the GetModuleFromDatabase method.

In embodiments of the invention, each module has a property named EmailAlias, which contains the e-mail address for the module, if there is one. When setting the e-mail address of a module, the EmailAlias property calls EmailMap.PutAlias.

Once the module representing the destination address in an e-mail is identified, the e-mail handler associated with the module is called, for example, by the GetHandler method mentioned above. In some embodiments of the invention, an e-mail handler class is established for each e-mail handler. An e-mail handler class is a subclass of an abstract base class called EmailHandler. A single instance of an EmailHandler class can handle e-mail for a single module.

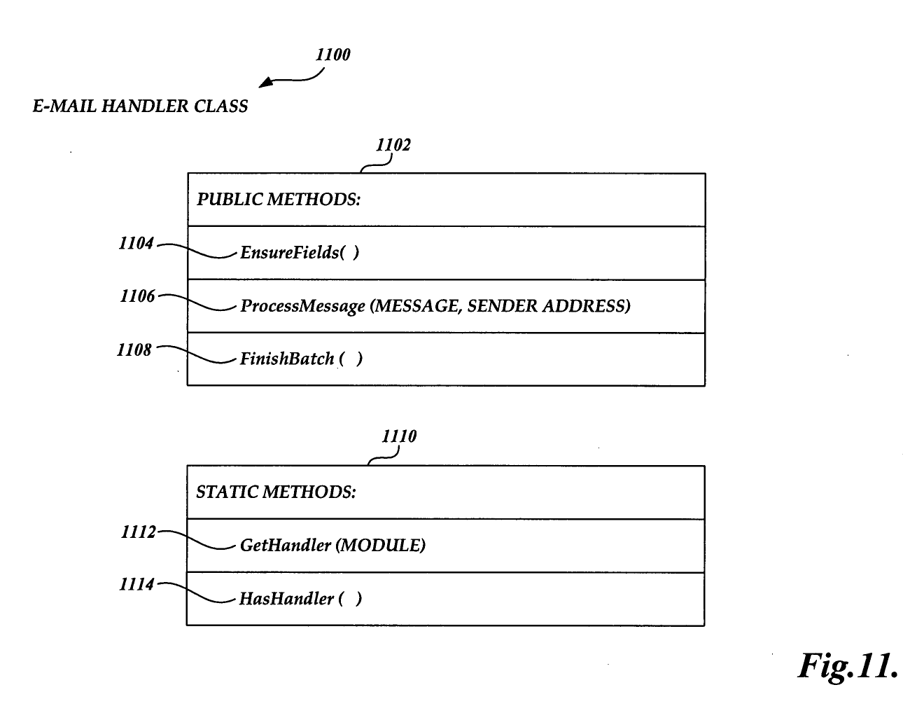

FIG. 11 illustrates one exemplary implementation of an EmailHandler class 1100. In embodiments of the invention, an EmailHandler class 1100 implements three public methods 1102. The method EnsureFields( ) is called when a module is first assigned an e-mail address. The method performs the setup necessary for the module to receive e-mail. For example, the method creates fields in the module to store corresponding e-mail fields.

Another public method for the EmailHandler class 1100 is ProcessMessage (message, sender address). This method delivers an incoming e-mail to the designated module. Generally, an e-mail handler can do anything with the information it obtains, i.e., the e-mail and the sender address. In an exemplary implementation of the ProcessMessage method 1106, the method 1106 stores the body and header of the e-mail in the designated module. In some embodiments of the invention, the method 1106 determines whether to delete the e-mail from the MailBox 810 at this moment or to preserve the e-mail until the processing of the batch e-mails has been completed. In the former case, the e-mail is deleted immediately. In the latter case, the e-mail is saved until the entire batch of e-mails has been processed.

The third public method is FinishBatch( ) 1108. This method is called at the end of any batch of e-mails on which this particular e-mail handler instance has been used. Generally, the method 1108 can do anything it wants. In an exemplary embodiment of the invention, the method 1108 finishes any e-mail filing tasks that are postponed in the ProcessMessage method 1106.

In embodiments of the invention, an EmailHandler class 1100 also contains two important static methods 1110. One of the static methods 1110 is named GetHandler(module) 1112. The GetHandler method 1112 constructs an e-mail handler subclass for the given module. The method 1112 is called by the EmailMap.GetHandler method discussed earlier. The method 1112 usually returns an appropriate e-mail handler class 1100 or NULL. In the case that the module has an external handler installed, then an external e-mail handler is returned.

Another important static method 1110 is called HasHandler( ) 1114. The method 1114 can be called by various user interfaces to determine if an e-mail option should be shown for a given module, based on its type. The HasHandler( ) method 1114 must return TRUE if and only if the GetHandler(module) method 1112 would return a non-NULL value. In embodiments of the invention, the EmailHandler class 1100 also implements a number of utility methods that are called by various methods in its subclasses.

An exemplary embodiment of the invention provides a few specific e-mail handler classes. They include e-mail handler classes for discussion boards, document libraries, etc. A generic e-mail handler class may be implemented for a module type, such as the announcement list.

An EmailHandler class 1100 may be provided for invoking a custom e-mail handler provided by a third party. Some embodiments of the invention allow a third party to provide a custom module for a Web site. If necessary, the third party also provides a custom e-mail handler for the custom module. The association between the custom module and its e-mail address is achieved by setting the EmailAlias property of the module. The association can also be set through a Web user interface that allows a user to set an e-mail address for a module. In the event a custom handler is installed for a module that already has a built-in e-mail handler, the built-in handler is no longer used.

### Section 3 E-mail View Forms

In embodiments of the invention, e-mail archives stored in a team site are accessible from an e-mail client, for example, by providing a connection from an e-mail back to the archive. In such an example, when a user types an e-mail address whose e-mails have been archived, a link will be added to the message, pointing the user to the Web site hosting the archive. In the case that the e-mail client is Microsoft® Outlook, the archive may also be stored in a public folder in Outlook. When a user actuates the link, the user will be led to the Outlook public folder. If the archive is not available in a public folder of the e-mail client, actuation of the link will lead the user to the Web site hosting the archive. In the case that a user does not have access to the Web site hosting the archive, the user will be redirected to a standard access request form.

In order to abstract a user away from the detail on whether an information item in an e-mail enabled Web site comes from an e-mail or from a post on the Web site, embodiments of the invention provide a link in the information item to detail the posting information. For example, when an information item comes from an e-mail, the information item may have a link to an e-mail detail page displaying the “TO,” “FROM,” “CC,” and “SENT DATE” fields of the e-mail.

Embodiments of the invention establish proper thread hierarchy for e-mails of a discussion thread in an e-mail enabled discussion board of a Web site. At times, a reply to an e-mail may arrive in the discussion board before the e-mail does. To ensure correct ordering of e-mails in a discussion thread, a placeholder is created for the missing e-mail. For example, e-mail A is the original message that initiates a discussion thread. E-mails B and C are replies to e-mail A, and e-mail D is a reply to e-mail B. Because of various hardware or software issues, e-mail D may arrive in the discussion board before e-mail B does. To archive e-mail D upon receiving it and to place it in the correct hierarchy order in the discussion thread, a placeholder is created for the missing e-mail B. E-mail B is written to the placeholder upon e-mail B eventually reaches the discussion board.

As those skilled in the art and other related fields will know, an e-mail in a discussion thread may contain specific information that identifies where the e-mail belongs in the thread hierarchy. For example, Microsoft® Exchange server associates a Thread-Index property to an e-mail. Each reply to the e-mail appends a five-byte encoded time stamp to the Thread-Index property. Consequently, the Thread-Index property in an e-mail reveals where the e-mail belongs in the discussion thread. For example, if e-mail A has a five-byte Thread-Index and the next received e-mail, e-mail D, has a twenty-byte Thread-Index, then it is estimated that two e-mails proceed e-mail D and have not been received; consequently, two place holders may be created when archiving e-mail D in the discussion board.

Embodiments of the invention also abstract e-mail reply history from an e-mail before writing it to its corresponding e-mail enabled module. The process is called e-mail trimming. Both the trimmed and untrimmed message bodies are saved. In the trimmed message, a link is provided to the untrimmed message body.

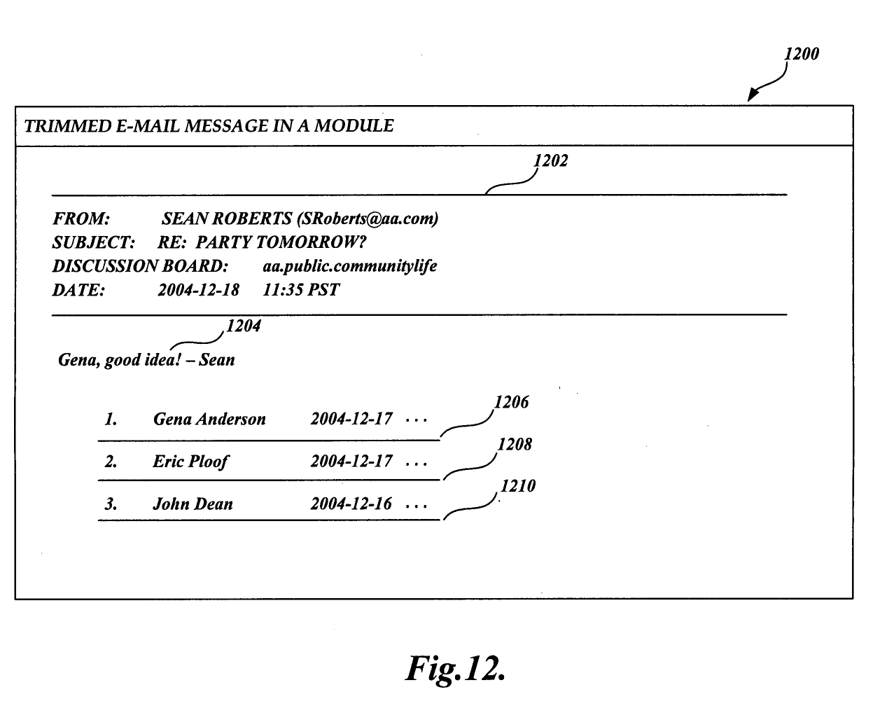

Generally, an e-mail contains the full reply history of a discussion thread. To avoid showing the reply history over and over again, embodiments of the invention trim the reply history of an e-mail before depositing it in a module. The trimmed e-mail may contain a link to the original untrimmed e-mail. Third parties may build their own version of the trimming process and link it into the corresponding custom e-mail handler. FIG. 12 illustrates a exemplary e-mail that has had its content trimmed. As shown in FIG. 12, the trimmed e-mail 1200 has its e-mail headers 1202 and message body 1204 intact. However, the reply histories have been shrunk into links. For example, the response 1206 from Gena Anderson is shrunk into Link 1; the response 1208 from Eric Ploof is shrunk into Link 2; and the response 1210 from John Dean is shrunk into Link 3. In embodiments of the invention, the trimming feature can be disabled and enabled by a user.

### Section 4 Managing E-mail Enabled Web Sites

Embodiments of the invention also provide centralized administration of a computing system such as the computing system 800 illustrated in FIG. 8. The configuration of the e-mail integration process is done on a Web server 808. The configuration then is pushed out to other Web servers if the computing system 800 contains multiple Web servers 808.

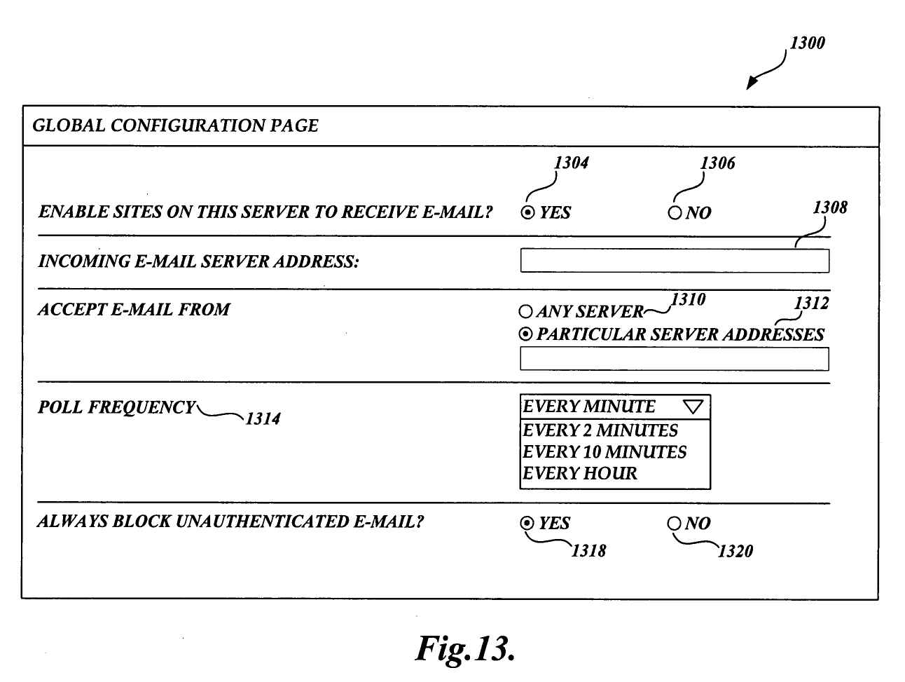

FIG. 13 provides an exemplary global configuration user interface 1300 that provides centralized configuration for allowing a team site hosted on a Web server to receive and process e-mails. The user interface 1300 allows a user to change the e-mail settings for a Web server. A user can enable or disable incoming e-mail, choose e-mail options, and configure the directory management service 612 discussed earlier. For example, as illustrated in FIG. 13, the user interface 1300 allows a user to enable sites on the Web server to receive e-mail by the user actuating either the YES button 1304 or the NO button 1306. In the event that a user allows sites on the Web server to receive e-mails, the user specifies the address 1308 of the e-mail server, i.e., the mail router 806 illustrated in FIG. 8, that sends the incoming e-mails to the Web server. Additionally, the user interface 1300 allows a user to specify whether to accept e-mail from any e-mail server or from particular server addresses by selecting option 1310 or option 1312, respectively. The user interface 1300 also allows a user to specify the frequency 1314 with which the timed e-mail service 812 (FIG. 8) polls the MailBox 810 to check if there are incoming e-mails. For example, as shown in FIG. 13, the poll frequencies 1314 can be every minute, every two minutes, every 10 minutes, or every hour. Finally, the user interface 1300 allows a user to specify whether or not to always block unauthenticated e-mail by actuating the YES button 1318 or the NO button 1320.

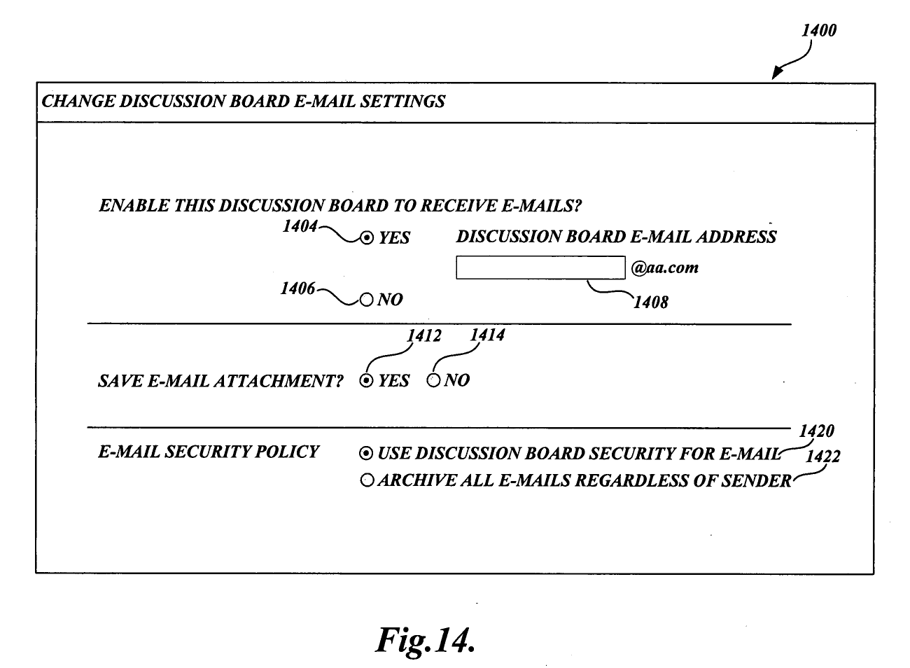

Embodiments of the invention also allow a user to change the e-mail settings of a module of a team site. In embodiments of the invention, the user interface for changing a module's e-mail settings is unique for each e-mail handler or each module type. FIG. 14 illustrates a user interface 1400 for configuring e-mail settings for a discussion board. The user interface 1400 allows a user to specify whether to enable the discussion board to receive e-mails by actuating the YES button 1404 or the NO button 1406. In the event that the user chooses to enable the discussion board to receive e-mails, the user may specify the corresponding discussion board e-mail address 1408.

The user interface 1400 also allows a user to specify whether to save attachments associated with an e-mail sent to the discussion board. If a user actuates the YES button 1412, e-mail attachments are saved, for example, in a document library associated with the team site hosting the discussion board. If a user actuates the NO button 1414, the corresponding e-mail handler will discard any e-mail attachments. In addition, the user interface 1400 allows a user to specify the security policy for incoming e-mails. In the event that a directory management service 612 (FIG. 6) is used, a user may adopt the security policy of the corresponding module for the e-mail security policy by selecting option 1420. This setting will block unauthenticated users. When no directory management service 612 is available, a user may select the option 1422 to archive all e-mails regardless of sender. This setting allows all users to send e-mail to an e-mail enabled module of a Web site.

While the preferred embodiments of the invention have been illustrated and described, it will be appreciated that various changes can be made therein without departing from the spirit and scope of the invention.

1. A computer-implemented method for enabling a Web site to receive and process e-mail, comprising:
enabling e-mail functionality for a module of the Web site; and
creating a distribution list for the Web site, wherein the distribution list containing e-mail addresses of an authorized user of the Web site and of the e-mail enable module of the Web site.

2. The computer-implemented method of claim 1, further comprising archiving e-mail sent to the distribution list in the Web site.

3. The computer-implemented method of claim 1, further comprising automatically embedding a link to the Web site in e-mail addressed to the distribution list.

4. The computer-implemented method of claim 1, wherein the module of a Web site is chosen from the group comprising a discussion board, a calendar, a document library, and an announcement list.

5. The computer-implemented method of claim 1, wherein the Web site issues a request to manage an e-mail address associated with the Web site.

6. The computer-implemented method of claim 5, wherein the request is performed by a directory management service.

7. The computer-implemented method of claim 6, wherein the directory management service first seeks permission execute the request.

8. The computer-implemented method of claim 7, wherein the permission may be granted either manually by a human or by an automated process.

9. A computer-implemented method for sending an e-mail to an e-mail enabled module of a Web site, comprising:
identifying the destination e-mail address in an incoming e-mail;
locating an e-mail enabled module associated with the destination e-mail address; and
associating the e-mail with the e-mail enabled module.

10. The computer-implemented method of claim 9, wherein an e-mail enabled module of the Web site is chosen from the group comprising a discussion board, a calendar, a document library, and an announcement list.

11. The computer-implemented method of claim 9, wherein locating an e-mail enabled module associated with the destination e-mail address includes searching a table containing an entry that maps the destination e-mail address with the e-mail enabled module.

12. The computer-implemented method of claim 9, wherein associating the e-mail with the e-mail enabled module includes identifying an e-mail handler associated with the e-mail enabled module, wherein the e-mail handler processes the e-mail before associating the e-mail with the e-mail enabled module.

13. The computer-implemented method of claim 12, wherein processing the e-mail includes authenticating the e-mail to ensure it comes from a welcomed sender.

14. The computer-implemented method of claim 12, wherein processing the e-mail includes ensuring the e-mail is not duplicated.

15. The computer-implemented method of claim 12, wherein processing the e-mail includes creating a placeholder for a missing e-mail that should have arrived before the e-mail being processed, if the e-mail being processed and the missing e-mail belong to the same discussion thread.

16. The computer-implemented method of claim 12, wherein processing the e-mail includes trimming the content of the e-mail.

17. The computer-implemented method of claim 16, wherein trimming the content of the e-mail includes abstracting reply history included in the e-mail into a link, the actuation of which leads to the reply history.

18. A computing system for sending an e-mail to an e-mail enabled module of a Web site, comprising:
(a) an e-mail client;
(b) an e-mail server; and
(c) a Web server, coupled with the e-mail client and the e-mail server, for:
(i) identifying the destination e-mail address in an e-mail;
(ii) locating an e-mail enabled module associated with the destination e-mail address; and
(iii) associating the e-mail with the e-mail enabled module.

19. The computing system of claim 18, wherein the e-mail enabled module of the Web site is chosen from the group comprising a discussion board, a calendar, a document library, and an announcement list.

20. The computing system of claim 18, wherein locating an e-mail enabled module associated with the destination e-mail address includes searching a table containing an entry that maps the destination e-mail address with the e-mail enabled module.

21. The computing system of claim 18, wherein associating the e-mail with the e-mail enabled module includes identifying an e-mail handler associated with the e-mail enabled module, wherein the e-mail handler processes the e-mail before associating the e-mail with the e-mail enabled module.

22. The computing system of claim 21, wherein the e-mail handler is custom designed to process e-mail for a particular e-mail enabled module of a Web site.

23. The computing system of claim 21, wherein processing the e-mail includes creating a placeholder for a missing e-mail that should have arrived before the e-mail being processed, if the e-mail being processed and the missing e-mail belong to the same discussion thread.

24. The computing system of claim 21, wherein processing the e-mail includes trimming the content of the e-mail.

25. The computing system of claim 24, wherein trimming the content of the e-mail includes abstracting reply history included in the e-mail into a link, the actuation of which leads to the reply history.

26. A computer-implemented method for enabling a Web site to receive and process e-mail, comprising:
associating a Web site with one or more e-mail addresses;
processing e-mail directed to an e-mail address of the Web site; and
archiving the e-mail in the Web site.

27. The computer-implemented method of claim 26, further comprising automatically embedding a link to the Web site in e-mail directed to an e-mail address of the Web site.

28. The computer-implemented method of claim 26, wherein the e-mail address of the Web site is mapped to an e-mail enabled module of the Web site.

29. The computer-implemented method of claim 28, wherein the e-mail enabled module of the Web site is chosen from the group comprising a discussion board, a calendar, a document library, and an announcement list.

30. The computer-implemented method of claim 28, wherein processing an e-mail directed to an e-mail address of the Web site further includes:
locating an e-mail enabled module associated with the e-mail address; and
associating the e-mail with the e-mail enabled module.

31. The computer-implemented method of claim 30, wherein locating an e-mail enabled module associated with the e-mail address includes searching a table containing an entry that maps the e-mail address with the e-mail enabled module.

32. The computer-implemented method of claim 30, wherein associating the e-mail with the e-mail enabled module includes identifying an e-mail handler associated with the e-mail enabled module, wherein the e-mail handler processes the e-mail before associating the e-mail with the e-mail enabled module.

33. The computer-implemented method of claim 32, wherein the e-mail handler is custom designed to process e-mail for a particular e-mail enabled module of a Web site.

34. The computer-implemented method of claim 32, wherein processing the e-mail includes creating a placeholder for a missing e-mail that should have arrived before the e-mail being processed, if the e-mail being processed and the missing e-mail belong to the same discussion thread.

35. The computer-implemented method of claim 32, wherein processing the e-mail includes trimming the content of the e-mail.

36. The computer-implemented method of claim 35, wherein trimming the content of the e-mail includes abstracting reply history included in the e-mail into a link, the actuation of which leads to the reply history.
